(19) United States
(12) Patent Application Publication
(10) Pub. No.: US 2022/0380197 A1
(43) Pub. Date: Dec. 1, 2022

(54) BACKSPLASH PROTECTOR

(71) Applicant: John Akerman Onkka, Beaverton, OR (US)

(72) Inventor: John Akerman Onkka, Beaverton, OR (US)

(21) Appl. No.: 17/334,180

(22) Filed: May 28, 2021

(51) Int. Cl. B67D 7/32; B62J 35/00

(52) U.S. Cl. CPC B67D 7/3209; B62J 35/00

(57) ABSTRACT

A backsplash protector device for use with a fuel tank or a motorcycle gas tank to prevent fuel from jumping or splashing from the opening of the gas tank during a fuel filling operation, and a vapor tube lock device for application to a gas nozzle to hold the vapor tube of the gas nozzle in a retracted or compressed position to permit a greater portion of the nozzle to be inserted through the backsplash protector and into the fuel tank without obscuring or blocking the user's ability to visually monitor the fuel flow, the fuel level within the tank, and/or the relative position of the nozzle (and the nozzle end from which fuel flows) within the tank.

### FIELD

Embodiments of the subject matter disclosed herein relate to a fuel filler backsplash protector device for use with a vehicle fuel/gas tank and a fuel/gas tank fuel filler therefor, as well as a vapor tube lock device for application with a fuel/gas nozzle.

### BACKGROUND

Filling fuel/gasoline tanks typically involves insertion of a fuel/gas nozzle into the fuel filler of the fuel/gas tank and squeezing the handle of the gas nozzle to initiate the flow of fuel into the fuel tank via the opening in the fuel tank (or fuel filler). Fuel tanks such as vehicle gas tanks, and especially motorcycle gas tanks, present a problem in that fuel/gasoline droplets frequently jump out from the top of the fuel tank during a fill up, which can be potentially corrosive and stain the paint/coating/surface finish of the (e.g., motorcycle) gas tank. Often a gas station attendant will hand a rider a paper towel to place over the gas tank cover, near the nozzle while the nozzle is inserted into the fuel filler of the tank, the paper towel intended to catch (and absorb) jumping gasoline/fuel droplets.

This method, however, is not always effective and provides no visibility into the fuel tank itself.

Further, this method allows gasoline/fuel to soak through the paper towel and onto the (vehicle/motorcycle) rider's hands or gloves.

Further still, fuel/gas nozzles are sometimes equipped with a vapor tube comprising a baffled or accordion-like vapor capture tube that extends downward from the nozzle handle to toward the fuel/gas dispensing end of the nozzle. The vapor tube extends downward over at least a portion of the nozzle and has a size (diameter and length) so as to impede or completely block visibility into the fuel tank, making it more difficult to visually check the level of fuel in the tank and/or monitor fuel flow into the tank.

The aforementioned and other fueling problems are especially troublesome for motorcycle and similar fuel tanks having a fuel filling opening at or near the top of the tank.

What is needed, therefore, are products and methods that address the aforementioned and other shortcomings and problems.

### BRIEF DESCRIPTION

Embodiments of the present disclosure relate generally to a backsplash protector device for use with a vehicle fuel/gas tank having a fuel/gas tank fuel filler to prevent fuel from jumping/splashing from the fuel filler or gas tank during a fuel filling operation, and also a vapor tube lock device for application to a fuel/gas nozzle to hold a vapor tube of the fuel nozzle in a retracted (compressed or shortened length) position enabling a greater portion of the nozzle to be inserted through the backsplash protector and into the fuel tank without obscuring or blocking the user's ability to visually monitor the fuel flow, the fuel level within the tank, and/or the relative position of the nozzle (and the nozzle end from which fuel is flowed) within the tank.

The present disclosure comprises embodiments of a backsplash protector designed to comprise a thin transparent plastic cover that is placed on top of the gasoline fueling hole (or fuel filler of the fuel tank) before inserting the gas nozzle into the gas tank. The cover (or backsplash protector) acts as a barrier to prevent gasoline droplets from jumping out of the tank during filling. The transparency of the plastic also allows the user to watch and gauge the rising fuel levels in the gas tank, to manually discontinue pumping (fueling) if the gas pump handle itself fails to do so (e.g., automatically).

Embodiments of the backsplash protector may be circular in overall shape, preferably no more than three (3) inches in diameter, preferably no more than ¾ of an inch high in total, so as to fit easily in any (or commonly available) pocket, bike storage, bag, jacket pocket, and the like. The material preferably comprises a transparent, translucent, or substantially see-through material such as transparent, translucent, or substantially see-through plastic. The bottom of the backsplash protector preferably comprises a shallow rounded cone shape to it, to encourage any backsplash to roll back to the middle of the gas tank filler hole instead of towards the edges. The rounded bottom also allows the protector to be more universal to fit a variety of applications (e.g., different style motorcycle fuel tanks) if there are varying sizes in filler hole diameters between, for example, different motorcycle brands. The female hole in the center of the protector, where the fuel/gas pump nozzle would be inserted therethrough, is preferably slightly angled (preferably between 75 to 80 degrees from the plane defined by the outer perimeter/rim of the protector) in order to catch any droplets bouncing straight up, and slightly larger (in its opening/hole diameter) than the diameter of a standard gas pump nozzle, preferably around 0.90 inches in diameter. The female hole, with its angled orientation with respect to the rest of the bowl-shaped protector, preferably comprises an oblique cylinder extending from the bottom of the protector upward, with a hole extending therethrough so as to permit a gas nozzle end to be inserted through the protector. The angled orientation of the hole further allows for the hole (and walls of the oblique cylinder) to be aligned in an upright or more upright (or more vertical) orientation with the ground when the gas tank to be filled is at an angle, such as is often the case, for example, when the motorcycle is resting on its kickstand (as most motorcycles use kickstand whereby the bike rests at an angle away from an upright 90 degrees/perpendicular angle to the ground, to an angle, for example, of approximately 70 to 80 degrees. In preferred embodiments, the protector is created as one solid piece via plastic injection molding techniques, and having a material wall thickness, for example, of about 1/16 inch all around/throughout the formed protector.

The present disclosure further comprises embodiments including a vapor tube lock designed to comprise a thin plastic clip or substantially “V” shaped flat sheet sized so as to receive the neck of the nozzle and grip diameter transitions along the nozzle permitting the user to lock the vapor tube of the gas nozzle in a retracted or compressed position so that a greater (i.e., longer) portion of the nozzle (nozzle end) is exposed and free of the vapor tube. In this way, the greater portion of the nozzle is usable for insertion through the backsplash protector device. In preferred embodiments, the vapor tube lock device comprises material (such as molded or formed plastic) having a length of about 3 and ⅜^{th} inches, a width of about 2 and 3/16^{th} inches, and a thickness of about 1/16^{th} inch (or about 3 mm), with the narrow part of the “V” shape opening being sized to engage with a diameter of a gas nozzle (and diameter transitions thereon) so as to permit the lock device to hold back the vapor tube of the gas nozzle to expose a greater length of the (fuel delivering) end of the gas pump nozzle.

Embodiments of the backsplash protector may further comprise standoffs, living hinges, or other protrusions or molded or formed features configured and sized to securably engage with and retain the vapor tube lock device, thereby providing for stowing the vapor tube lock (device) with the backsplash protector (device) as a combined, easily transportable backsplash protector-vapor tube lock assembly/apparatus. The standoffs (defining the vapor tube lock receiver) may comprise molded-in features extending (or protrusions) from the outer circumference/outer rim of the protector, with the protrusions sized to be received by (cooperatively mating or correspondingly sized) holes (slots) extending through the thickness dimension of the vapor tube lock material.

By using such a backsplash protector and/or a combination of a backsplash protector with a vapor tube lock, some or all of the aforementioned and other disadvantages and shortcomings of prior solutions and methods are improved, including, but not limited to, preventing backsplash of fuel from exiting the fuel filler during a fueling operation and permitting the user to visibly watch and monitor the fuel pump nozzle within the fuel filler and tank and fuel flowing into the fuel tank.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The accompanying drawings are incorporated herein as part of the specification. The drawings described herein illustrate embodiments of the presently disclosed subject matter, and are illustrative of selected principles and teachings of the present disclosure. However, the drawings do not illustrate all possible implementations of the presently disclosed subject matter, and are not intended to limit the scope of the present disclosure in any way. The above, as well as other advantages of the present disclosure will become readily apparent to those skilled in the art from the following detailed description when considered in the light of the accompanying drawings.

FIG. 1 is a top view of a backsplash protector, according to embodiments.

FIG. 2 is side cut view of the backsplash protector shown in FIG. 2, according to embodiments.

FIG. 3 is a top view of a vapor tube lock for use with the backsplash protector in FIG. 1, according to embodiments.

FIG. 4 is a perspective view of a backsplash protector placed over a motorcycle gas tank opening and with a gas pump nozzle extending through the protector into the gas tank, according to embodiments.

FIG. 5 is a perspective view of a backsplash protector placed over a motorcycle gas tank opening having a hinged lid affixed proximate thereto, and with a gas pump nozzle held by a rider/user, showing the gas pump nozzle extending through the protector in the gas tank, according to embodiments.

FIG. 6 is a perspective view of a vapor tube lock placed along a fuel delivering end portion of a gas pump nozzle so as to hold a vapor tube of the gas pump nozzle in a retracted position to expose a greater portion of the fuel delivering end portion of the gas pump nozzle, according to embodiments.

FIG. 7 is a perspective view of a backsplash protector having a vapor tube lock securably stowed thereon, according to embodiments.

FIG. 7 includes illustration of features which, according to various embodiments, are depicted to be approximately proportionate with one another.

### DETAILED DESCRIPTION

It is to be understood that embodiments of the present disclosure may assume various alternative orientations and step sequences, except where expressly specified to the contrary. It is also to be understood that the assemblies, devices, and methods illustrated in the attached drawings, and described in the following specification are simply exemplary embodiments of the inventive concepts. Hence, specific dimensions, directions, or other physical characteristics relating to the embodiments disclosed, if any, are not to be considered as limiting, unless expressly stated otherwise.

The present inventor discovered a backsplash protector device for use with a vehicle fuel tank having a fuel tank filler/opening, whereby the device prevents fuel from jumping or splashing out of the fuel filler or fuel tank during a fuel filling operation, and also a vapor tube lock device for application to a fuel pump nozzle that holds a vapor tube of the fuel nozzle in a retracted (or compressed or shortened length) position enabling a greater portion of the nozzle to be inserted through the backsplash protector and into the fuel tank without obscuring or blocking the user's ability to visually monitor the fuel flow, the fuel level within the tank, and/or the relative position of the nozzle (and the nozzle end from which fuel is flowed) within the tank. The backsplash protector, in preferred embodiments, generally comprises a small cone or round bottomed cover with a hole therethrough sized to receive the end of a fuel pump nozzle. The inventor discovered using transparent or translucent or at least partially see-through material for the protector provides visibility of the fuel flowing from the fuel pump nozzle, the relative position of the end of the fuel pump nozzle within the fuel tank, and the level of fuel within the fuel tank during the fueling operation. The present inventor further discovered a vapor tube lock that permits holding a vapor tube back away from the fuel pump nozzle so that visibility of the pump nozzle and the aforementioned visibility of fuel flowing, position of the nozzle end, and fuel level within the tank, are improved, such improvements permitting fuel filling with reduced incidence or chances of fuel splashing onto exterior portions of the fuel tank, the user, or other areas.

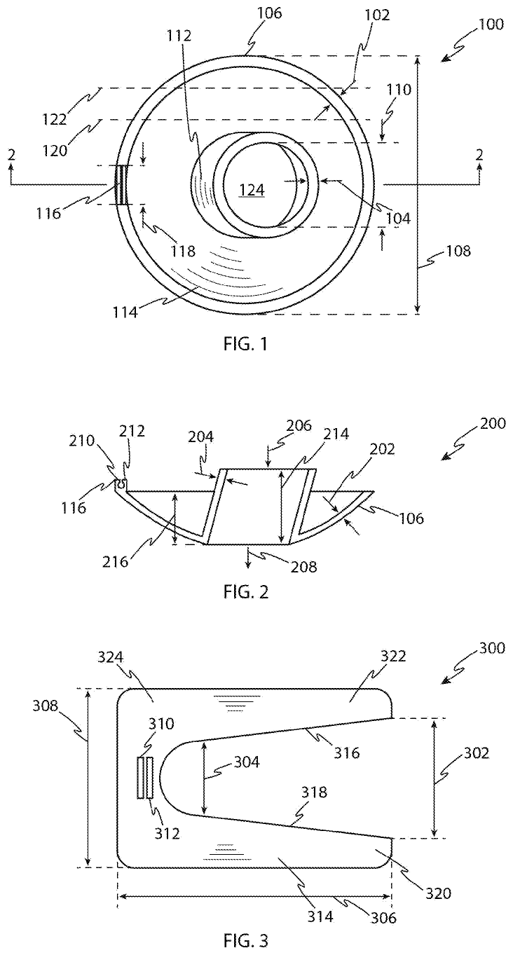

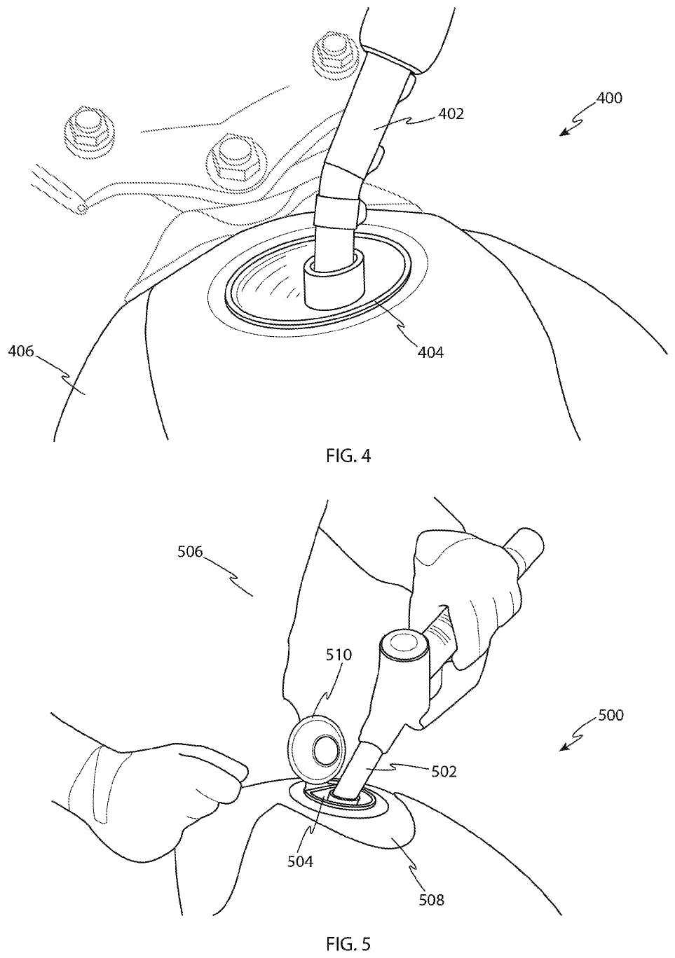

As an overview, the top view and side view of FIGS. 1 and 2, respectively, show a bottom portion and cylinder of a backsplash protector, in preferred embodiments; FIG. 3 is a top view of a vapor tube lock, according to preferred embodiments, for use with the backsplash protector in FIG. 1; FIGS. 4-6 provide exemplary contextual representations for use of the backsplash protector and/or the vapor tube lock, according to preferred embodiments; and FIG. 7 illustrates a vapor tube lock stowed on a backsplash protector, as in preferred embodiments.

Turning now to the figures, FIG. 1 illustrates a top view 100 of a backsplash protector 106, and FIG. 2 is side cut view 200 of the backsplash protector 106 (i.e., cut along a diameter of the protector 106), according to embodiments. As shown, a backsplash protector, such as the backsplash protector 106, preferably comprises a bottom portion having a shallow rounded cone shape or a bowl shape, the bottom portion sized and configured to removably fit over an opening of a fuel tank or a motorcycle gas tank and to catch and redirect backsplash of fuel being supplied into the tank back into the tank, and a hole 124 in the bottom portion, the hole 124 comprising a cylinder (with cylinder walls or sides 112 extending upward from a bottom surface of the protector, with the hole extending from an opening 206 through the cylinder and out through a bottom opening/exit 208 of the cylinder, and with the hole 124 (from opening 206 to opening/exit 208) sized so as to permit a gas nozzle end to be inserted through the hole and to permit fuel to flow from the gas nozzle end into the tank. The bottom portion and the cylinder preferably comprise a transparent or translucent or at least partially see-through material, whereby the transparent or translucent or at least partially see-through material permitting a user to view a fuel level within the tank, fuel flowing from the gas nozzle end, and/or backsplash or fuel being supplied into the tank.

As shown in the top view 100, the backsplash protector 106 preferably comprises a circular or substantially circular or at least a partially circular shaped device having a (outer) diameter 108, with the device bottom portion having an inner surface that is concave, extending from the opening (such as opening/exit 208) in the bottom surface of the bottom portion upward so as to form a shallow cone or bowl shaped bottom portion. The bowl shaped sides (and concave inner surface 114) preferably extend, as shown, upward to a circumferential rim shown with a rim width 102. Overall top view shapes (e.g., defined by the top view shape by the circumferential rim) other circular or substantially circular or at least partially circular may be used, such as for example, square, triangular, octagonal, etc., according to lesser preferred embodiments. The present inventor determined that an overall top view shape (e.g., defined by the bottom portion rim having rim width 102) that is circular or substantially circular or at least partially circular is effective and practical for use with most fuel tanks, which typically comprise a circular shaped fuel tank opening (or fuel filler/fuel filler opening).

The present inventor determined a convex exterior bottom surface of the bowl shaped protector 106 provides bottom surfaces that will catch backsplash of fuel (gas) as fuel is being flowed through a gas nozzle end extended through the hole 124 from the hole's top opening 206 and out of the hole's bottom opening/exit 208, and redirect the backsplash (after hitting the convex bottom surfaces and flowing or dripping downward) back into the fuel tank therebelow. Shapes other than a shallow rounded cone or bowl shape may be used, however, the present inventor determined that such shallow rounded cone or bowl shape is preferable so as to more effectively fit down into fuel tank openings, which are most typically substantially circular, and more effectively capture backsplash from the fuel tank.

Also shown extending from the bottom surface opening (e.g., opening/exit 208) is a cylinder having an inner (hole) diameter 110 and outer side walls (or sides or walls) 112. The cylinder side walls are shown extending upward from the bottom to a cylinder rim having cylinder rim width 104. The cylinder, as shown in FIGS. 1 and 2, preferably comprises side walls extending upward from the bottom surface of the protector so as to form an oblique cylinder. The oblique cylinder preferably comprises an angle extending from the bottom surface of the protector configured to catch and redirect backsplash of fuel being supplied into the tank back into the tank and/or to permit insertion of the gas nozzle end at a gas nozzle end insertion angle corresponding with the angle of the oblique cylinder. The angle of the oblique cylinder (i.e., the angle of side walls 112 as measured from a horizontal plane defined by the opening/exit 208 of the hole 124 shown in the cut view 200 in FIG. 2) may be any angle other than 90 degrees (which comprise a standard right angle sided cylinder and would not comprise an oblique cylinder).

In preferred embodiments the angle of the oblique cylinder is greater than or equal to 70 degrees and less than or equal to 80 degrees. The lower the angle, the present inventor determined, the more effectively the inner walls of the cylinder (inner walls defining the hole 124) may capture backsplash of fuel jumping or splashing directly back up through the hold 124. However, the present inventor determined that an angle between 69 and 81 degrees is reasonably effective and may generally match an (offset) angle at which a typical motorcycle (and its fuel tank thereon) may rest when using a typical motorcycle kickstand.

In preferred embodiments, the bottom portion and the cylinder comprise a plastic material, preferably a transparent or translucent or at least partially see-through plastic material. The plastic material preferably comprises an injection molded material. In some embodiments, the bottom portion and the cylinder comprise one solid piece of injection molded plastic material. In some embodiments, the cylinder material thickness 204 and the bottom portion material thickness 202 are both approximately 3 mm or approximately 1/16^{th} inch.

In some embodiments, and as shown in FIG. 2, the backsplash protector comprises a bowl height 216 (the bowl height 216 being the measured distance between the bottom of the cylinder and the circumferential rim of the bowl shape) that is less than a cylinder height 214 (the cylinder height 214 being the measured distance between the cylinder bottom and the upper rim opening of the cylinder). In less preferred embodiments the bowl height 216 may be the same or greater than the cylinder height 214. The present inventor determined that a bowl height 216 that is lower than the cylinder height 214 provides adequate coverage (of the bottom portion) over typical fuel tank openings, with the increased cylinder height 214 providing additional surfaces (i.e., the inner surface of the cylinder hole 124) for catching backsplash of fuel from exiting out of the cylinder opening 216.

The present inventor determined that a backsplash protector with an overall height of no more than ¾ inch and an overall diameter or width of no more than 3 inches is preferred. For example, the overall height of the protector 106 may comprise the cylinder height and is preferably less than or equal to ¾ inch. In some embodiments wherein the bottom portion is circular, the diameter or overall width (as measured in a top view) of the protector is preferably less than or equal to 3 inches. In one embodiment, the bottom portion is circular shaped or substantially circular in shape or at least partially circular in shape, and the diameter or overall width of the protector (as measured in a top view) is approximately 2 and ¾ inches. In one embodiment, the cylinder hole diameter 110 is approximately 24 mm.

Next, FIG. 3 is a top view 300 of a vapor tube lock for use with the backsplash protector in FIG. 1, according to embodiments. In some embodiments the backsplash protector, such as the backsplash protector 106 in FIGS. 1 and 2, comprises a vapor tube lock as shown in FIG. 3. In some embodiments, a vapor tube lock comprises a “V” shaped card 314 or a flat sheet with a “V” shaped opening sized so as to receive a gas nozzle neck portion (such as, for example, along a gas nozzle neck portion 602 as shown in FIG. 6) extending from a gas nozzle end and to grip one or more diameter transitions along the gas nozzle neck permitting a user of the vapor tube lock device to lock a vapor tube (such as, for example, a vapor tube 604 as shown in FIG. 6) (that otherwise extends downward over the gas nozzle neck portion) in a retracted or compressed position so that a greater portion of the gas nozzle neck is exposed and free of the vapor tube, the greater portion of the gas nozzle neck thereby being usable for insertion through the hole in the backsplash protector, such as, for example the hole 124. As shown in FIG. 3, the vapor tube lock device may comprise flat sheet or substantially flat sheet or card having a length 306 and a width 308, with an opening at one end having an opening between open or outward portions, 320 and 322, of the “V” shape. The opening between outward portions 320 and 322 may comprise a opening width 302. The sides of the “V” shape, 316 and 318, extend from the open end so as to narrow down to a closed end 324 of the vapor tube lock device. In one embodiment, the sides of the “V” shape 316 and 318 are each substantially straight or linear from the opening to a diameter 304, whereafter the sides 316, 318 transition through the closed end 324 via a radius of ½ of the diameter 304.

In some embodiments, the vapor tube lock comprises material having a length 306 of about 3 and ⅜^{th} inches, a width 308 of about 2and 3/16^{th} inches, and a thickness of about 1116^{th} inch, with a narrow part of the “V” shape opening (having the diameter 304) being sized to engage with a diameter of a gas nozzle neck (such as, for example, a gas nozzle neck 602 as shown in FIG. 6) and at least one diameter transition thereon so as to permit the vapor tube lock to hold back a vapor tube (such as, for example, a vapor tube 604 as shown in FIG. 6) to expose a greater portion of the gas nozzle neck.

Referring back to FIGS. 1 and 2, and further referring to FIG. 7, in some embodiments, the backsplash protector 106 may comprise standoffs, living hinges, or protrusions or molded or formed features (such as, for example, vapor tube lock receiver 116 or standoffs 210 and 212) configured and sized to securably engage with cooperatively mating slots or molded or formed features of the vapor tube lock (such as, for example, slots 310 and 312), thereby permitting stowage of the vapor tube lock device on the backsplash protector. In one embodiment, as shown in FIGS. 1, 2, and 3, standoff or molded-in protrusions 210 and 212 extending away (upward) from the circumferential rim of the bottom portion (bowl shaped portion) of the protector 106 are configured so as to be received into respectively correspondingly sized slots 310 and 312 formed in the flat sheet material comprising the closed end 324 of the vapor tube lock device. Described another way, the two protrusions 210 and 212 shown in FIG. 2 may comprise a receiver (between the two structures 210 and 212) configured and sized to receive the material between slots 310 and 312 shown in FIG. 3. In this way, the vapor tube lock device may be removably securably attached to (i.e., stowed with) the backsplash protector.

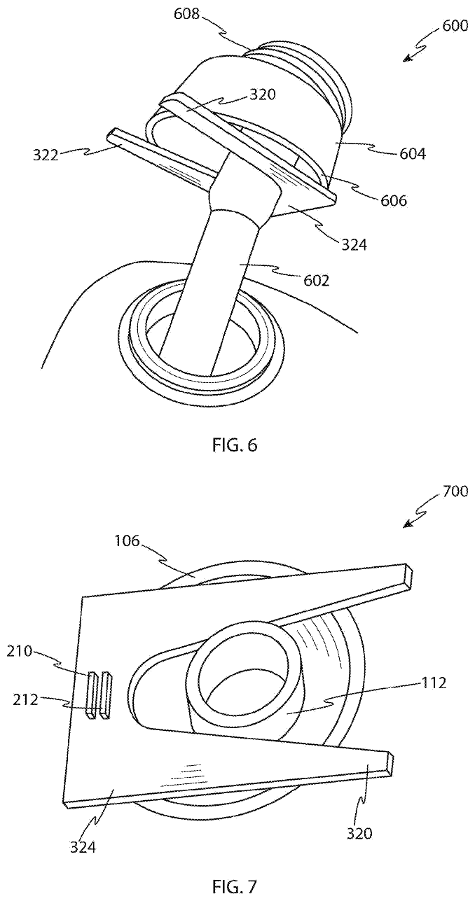

Turning now to FIGS. 4-6, FIG. 4 is a perspective view 400 of a backsplash protector placed over a motorcycle gas tank 406 opening and with a gas pump nozzle 402 extending through the protector 404 into the gas tank, according to embodiments. The protector is preferably a backsplash protector 106 as shown in FIGS. 1 and 2, comprising a circular shaped protector. FIG. 5 is a perspective view 500 of a backsplash protector 504 placed over a motorcycle gas tank opening having a hinged lid 510 affixed proximate thereto, and with a gas pump nozzle 502 held by a rider/user 506, showing the gas pump nozzle extending through the protector 504 in the gas tank 508, according to embodiments. The protector 504 illustrated in FIG. 5 is intended to show a variation of the protector 106 whereby a section of the bottom portion (or bowl shaped portion) of the protector is cut along, for example, 120 or 122 shown in FIG. 1, or molded so that the bottom portion rim or circumferential rim runs along rim line 120 or 122, providing a flat or cut or shortened edge portion of the protector, sized and configured to accommodate a hinge or hinge structure of a hinged gas tank lid such as lid 510.

The present inventor determined that typical hinged motorcycle gas tank lids easily accommodate and allow for use of a backsplash protector without a cut or shortened edge portion, because preferred embodiments are sized and proportioned as described in the preferred embodiments herein so that the protector fits downward into the opening of a typical motorcycle fuel tank opening.

FIGS. 4 and 5 illustrate use of a backsplash protector, according to embodiments. In preferred embodiments, a method of filling a fuel tank or a motorcycle gas tank comprises placing a backsplash protector over an opening to the fuel tank or the motorcycle gas tank, wherein the backsplash protector comprises a bottom portion having a shallow rounded cone shape or a bowl shape, the bottom portion sized and configured to removably fit over the opening of the fuel tank or the motorcycle gas tank and to catch and redirect backsplash of fuel being supplied into the tank back into the tank, and a hole in the bottom portion, the hole comprising a cylinder extending upward from a bottom surface of the protector, with the hole extending through the cylinder and sized so as to permit a gas nozzle end to be inserted through the hole and to permit fuel to flow from the gas nozzle end into the tank, wherein the bottom portion and the cylinder comprise a transparent or translucent or at least partially see-through material, the transparent or translucent or at least partially see-through material permitting a user to view a fuel level within the tank, fuel flowing from the gas nozzle end, and/or backsplash or fuel being supplied into the tank. In embodiments, the method further includes inserting the gas nozzle end through the hole extending through the cylinder of the backsplash protector, and filling the tank with fuel. In embodiments, the user/rider views through the backsplash protector the fuel level within the tank, fuel flowing from the gas nozzle end, and/or backsplash or fuel being supplied into the tank.

FIG. 6 is a perspective view 600 of a vapor tube lock placed along a fuel delivering end portion (or gas nozzle neck portion 602) of a gas pump nozzle so as to hold a vapor tube 604 of the gas pump nozzle in a retracted position to expose a greater portion of the fuel delivering end portion of the gas pump nozzle, according to embodiments. As shown, the gas nozzle neck portion 602 is received into the open ends 320 and 322 of the “V” shaped vapor tube lock device so that the closed end 324 and the diameter 304 and radius associated therewith engage with a diameter of the gas nozzle neck and at least one diameter transition thereon so as to permit the vapor tube lock device to hold the vapor tube 604. Further as shown, material of the “V” shaped vapor tube lock device contact/engage with and hold the vapor tube end 606 so that the vapor tube is held in a retracted position and/or so that corrugations 608 of the vapor tube are held in a compressed orientation, so as to expose a greater portion of the fuel delivering end portion 602 of the gas pump nozzle.

In some embodiments, methods of using a backsplash protector further include using a vapor tube lock to lock a vapor tube that otherwise extends downward over a gas nozzle neck portion in a retracted or compressed position so that a greater portion of the gas nozzle neck is exposed and free of the vapor tube, the greater portion of the gas nozzle neck thereby being usable for insertion through the hole in the backsplash protector, wherein the vapor tube lock comprises a flat sheet with a “V” shaped opening sized so as to receive the gas nozzle neck portion extending from the gas nozzle end and grip one or more diameter transitions along the gas nozzle neck permitting the user to lock the vapor tube that otherwise extends downward over the gas nozzle neck portion in a retracted or compressed position so that a greater portion of the gas nozzle neck is exposed and free of the vapor tube.

In some embodiments, methods of using a backsplash protector and a vapor tube lock include stowing the vapor tube lock on the backsplash protector, wherein the protector comprises standoffs, living hinges, or protrusions or molded or formed features configured and sized to securably engage with cooperatively mating slots or molded or formed features of the vapor tube lock, thereby permitting stowage of the vapor tube lock on the backsplash protector.

FIG. 7 shows a perspective view 700 of a backsplash protector (such as protector 106) having a vapor tube lock (such as the vapor tube lock shown in FIG. 3) securably stowed thereon, according to embodiments. As shown, features (such as standoffs 210 and 212) of the protector 106 may permit securing the vapor tube lock device to the protector, with the side walls 112 of the cylinder extending upward through the “V” shaped opening of the vapor tube lock device.

The above described embodiments of a backsplash protector and/or a combination of a backsplash protector with a vapor tube lock, address disadvantages and shortcomings of prior solutions and methods by preventing backsplash of fuel from exiting the fuel filler/gas tank opening during a fueling operation and permitting the user to visibly watch and monitor the fuel pump nozzle within the fuel filler and tank, and fuel flowing into the fuel tank.

Although the present invention has been described with reference to preferred embodiments, numerous modifications and variations can be made and still fall within the scope of the invention. For example, increasing or decreasing the scale of the preferred embodiment or increasing the number of instances of the preferred embodiment will still fall within the scope of the invention.

FIGS. 1, 2, 3, and 7 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

Throughout this specification relative language such as the words ‘about’ and ‘approximately’ may be used. Unless otherwise specified or described, this language seeks to incorporate at least 10% variability to the specified number or range. That variability may be plus 10% or negative 10% of the particular number specified.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A backsplash protector comprising:
a bottom portion having a shallow rounded cone shape or a bowl shape, the bottom portion sized and configured to removably fit over an opening of a fuel tank or a motorcycle gas tank and to catch and redirect backsplash of fuel being supplied into the tank back into the tank; and
a hole in the bottom portion, the hole comprising a cylinder extending upward from a bottom surface of the protector, with the hole extending through the cylinder and sized so as to permit a gas nozzle end to be inserted through the hole and to permit fuel to flow from the gas nozzle end into the tank, wherein the bottom portion and the cylinder comprise a transparent or translucent or at least partially see-through material, the transparent or translucent or at least partially see-through material permitting a user to view a fuel level within the tank, fuel flowing from the gas nozzle end, and/or backsplash or fuel being supplied into the tank.

2. The backsplash protector of claim 1, wherein the cylinder extending upward from the bottom surface of the protector comprises an oblique cylinder.

3. The backsplash protector of claim 2, wherein the oblique cylinder comprises an angle extending from the bottom surface of the protector configured to catch and redirect backsplash of fuel being supplied into the tank back into the tank and/or to permit insertion of the gas nozzle end at a gas nozzle end insertion angle corresponding with the angle of the oblique cylinder.

4. The backsplash protector of claim 1, wherein the bottom portion and the cylinder comprise a plastic material.

5. The backsplash protector of claim 4, wherein the plastic material comprises an injection molded material.

6. The backsplash protector of claim 5, wherein the bottom portion and the cylinder comprise one solid piece of injection molded plastic material.

7. The backsplash protector of claim 1, wherein the bottom portion comprises a bowl shape extending upward from the bottom surface and a bottom of the cylinder extending upward to a circumferential rim of the bowl shape.

8. The backsplash protector of claim 7, wherein the cylinder extends upward from the bottom of the cylinder to an upper rim opening of the cylinder.

9. The backsplash protector of claim 8, wherein a bowl height between the bottom of the cylinder and the circumferential rim of the bowl shape is less than a cylinder height between the cylinder bottom and the upper rim opening of the cylinder.

10. The backsplash protector of claim 9, wherein a height of the protector is the cylinder height and is less than or equal to ¾ inch.

11. The backsplash protector of claim 1, wherein the bottom portion is circular.

12. The backsplash protector of claim 11, wherein a diameter of the protector is less than or equal to 3 inches.

13. The backsplash protector of claim 3, wherein the angle of the oblique cylinder is greater than or equal to 70 degrees and less than or equal to 80 degrees.

14. The backsplash protector of claim 1, further comprising a vapor tube lock, the vapor tube lock comprising a flat sheet with a “V” shaped opening sized so as to receive a gas nozzle neck portion extending from the gas nozzle end and grip one or more diameter transitions along the gas nozzle neck permitting the user to lock a vapor tube that otherwise extends downward over the gas nozzle neck portion in a retracted or compressed position so that a greater portion of the gas nozzle neck is exposed and free of the vapor tube, the greater portion of the gas nozzle neck thereby being usable for insertion through the hole in the backsplash protector.

15. The backsplash protector of claim 14, wherein the vapor tube lock comprises material having a length of about 3 and ⅜^{th} inches, a width of about 2 and 3/16^{th} inches, and a thickness of about 1/16^{th} inch, with a narrow part of the “V” shape opening being sized to engage with a diameter of the gas nozzle neck and at least one diameter transition thereon so as to permit the vapor tube lock to hold back the vapor tube to expose the greater portion of the gas nozzle neck.

16. The backsplash protector of claim 14, wherein the protector further comprises standoffs, living hinges, or protrusions or molded or formed features configured and sized to securably engage with cooperatively mating slots or molded or formed features of the vapor tube lock, thereby permitting stowage of the vapor tube lock on the backsplash protector.

17. A method of filling a fuel tank or a motorcycle gas tank, comprising:
placing a backsplash protector over an opening to the fuel tank or the motorcycle gas tank, wherein the backsplash protector comprises:
a bottom portion having a shallow rounded cone shape or a bowl shape, the bottom portion sized and configured to removably fit over the opening of the fuel tank or the motorcycle gas tank and to catch and redirect backsplash of fuel being supplied into the tank back into the tank; and
a hole in the bottom portion, the hole comprising a cylinder extending upward from a bottom surface of the protector, with the hole extending through the cylinder and sized so as to permit a gas nozzle end to be inserted through the hole and to permit fuel to flow from the gas nozzle end into the tank, wherein the bottom portion and the cylinder comprise a transparent or translucent or at least partially see-through material, the transparent or translucent or at least partially see-through material permitting a user to view a fuel level within the tank, fuel flowing from the gas nozzle end, and/or backsplash or fuel being supplied into the tank.

18. The method of claim 17, further comprising:
inserting the gas nozzle end through the hole extending through the cylinder of the backsplash protector; and
filling the tank with fuel.

19. The method of claim 18, further comprising:
using a vapor tube lock to lock a vapor tube that otherwise extends downward over a gas nozzle neck portion in a retracted or compressed position so that a greater portion of the gas nozzle neck is exposed and free of the vapor tube, the greater portion of the gas nozzle neck thereby being usable for insertion through the hole in the backsplash protector, wherein the vapor tube lock comprises a flat sheet with a “V” shaped opening sized so as to receive the gas nozzle neck portion extending from the gas nozzle end and grip one or more diameter transitions along the gas nozzle neck permitting the user to lock the vapor tube that otherwise extends downward over the gas nozzle neck portion in a retracted or compressed position so that a greater portion of the gas nozzle neck is exposed and free of the vapor tube.

20. The method of claim 19, further comprising:
stowing the vapor tube lock on the backsplash protector, wherein the protector comprises standoffs, living hinges, or protrusions or molded or formed features configured and sized to securably engage with cooperatively mating slots or molded or formed features of the vapor tube lock, thereby permitting stowage of the vapor tube lock on the backsplash protector.
